(19) United States
(12) Patent Application Publication
(10) Pub. No.: US 2016/0086176 A1
(43) Pub. Date: Mar. 24, 2016

(54) METHOD FOR MULTI-FACTOR TRANSACTION AUTHENTICATION USING WEARABLE DEVICES

(71) Applicant: SAMSUNG ELETRONICA DA AMAZONIA LTDA., CAMPINAS (BR)

(72) Inventors: BRENO SILVA PINTO, CAMPINAS (BR); FELIPE CAYE BATALHA BOEIRA, CAMPINAS (BR); ISAC SACCHI E SOUZA, CAMPINAS (BR); PAULO CESAR PIRES, CAMPINAS (BR); PEDRO HENRIQUE MINATEL, CAMPINAS (BR); MIGUEL LIZARRAGA, CAMPINAS (BR); BRUNNO FRIGO DA PURIFICAÇÃO, CAMPINAS (BR)

(73) Assignee: SAMSUNG ELETRONICA DA AMAZONIA LTDA., CAMPINAS (BR)

(21) Appl. No.: 14/532,554

(22) Filed: Nov. 4, 2014

(30) Foreign Application Priority Data
Sep. 18, 2014 (BR) 1020140232290

(51) Int. Cl. G06Q 20/40; H04W 12/12; H04L 29/06

(52) U.S. Cl. CPC G06Q 20/401; H04L 63/0838; H04L 63/0428; H04L 63/0853; H04W 12/12

(57) ABSTRACT

The present invention relates to a method (100) for multi-factor authentication, which uses wearable devices as a secondary device (204) in conjunction with a primary/main device (200) (e.g., the smartphone of user who conducts the electronic transaction) to allow the user to verify the data integrity of electronic transaction before authorizing it (out of possible compromised device e.g. smartphone).

### CROSS-REFERENCE TO RELATED APPLICATIONS

This application claims the priority benefit of Brazilian Application No. 10 2014 023229 0, filed Sep. 18, 2014, in the Brazilian Intellectual Property Office, the disclosure of which is incorporated herein by reference.

### BACKGROUND

1. Field

The proposed method is applied for authentication and authorization of transactions, using wearable devices in conjunction with a main/primary device (e.g.: smartphone) to perform secure online transactions by using a second device (e.g.: wearable devices), being more resistant to common attacks (such as man-in-the-middle).

2. Description of the Related Art

In the prior art, it is found a plurality of solutions and technologies that use wearable devices in order to authenticate and authorize transactions. However, the existing solutions that integrate a multi-factor authentication using wearable devices usually employ them only as a token. Hence the user is not able to verify the integrity of the transaction data.

Additionally, the existing technologies and solutions fail to improve the security against common attacks (such as man-in-the-middle attacks), since the wearable device is used to generate codes or keys to be inserted in the already compromised mobile device or computer.

A man-in-the-middle attack occurs when a third party's computer system interposes itself between a user's computer system (used to conduct an electronic transaction) and a service provider's computer system (which provides the service involved in the electronic transaction). While interposed between user's and service provider's computer systems, the third party's computer system intercepts sensitive user information and the electronic transaction information from the user's computer system, obtains access to the service provider's computer system using the sensitive user information, and conducts a distinct electronic transaction to benefit the third party (and not the original user). In order to avoid the user from noticing the user's transaction has been interrupted and modified by a man-in-the-middle attack, the third party's system sends to the user's system a fraudulent message (or a webpage) confirming the original user's electronic transaction, when, in fact, a distinct/fraudulent electronic transaction has been performed. So, when a man-in-the-middle attack occurs, the harmed user has no way of knowing it until the fraudulent electronic transaction has been finished—and the original user's electronic transaction has been discarded—by the third party system.

Patent document U.S. Pat. No. 8,371,501 B1, titled “Systems and Methods for a Wearable User Authentication Factor”, published on Feb. 12, 2013, describes a method for multi-factor authentication with an authentication factor of wearable device's user. A multi-factor authentication module is implemented to use a plurality of authentication factors, including a unique tag identifier associated with an electronic tag embedded within a wearable article, such as a ring or watch, for the authentication of a user. A user of an authentication factor of wearable device's user approaches a multi-factor terminal, which detects the electronic tag and reads its unique identifier. The user is then requested to provide a predetermined biometric feature, such as a fingerprint, to a biometric reader. The biometric feature is processed to generate a unique biometric identifier. The unique identifier of the electronic tag is then submitted to a multi-factor authentication module, which compares it to authentication information associated with the user. If the submitted unique identifiers match the user's authentication information, then the user is authenticated. In the proposed solution of document U.S. Pat. No. 8,371,501 B1, the wearable device is used to store a hardware that contains a unique identification in order to allow the user to authenticate. In the proposed method of the present invention, the wearable device is used to verify the integrity of a secure online transaction submitted by an external device such as a mobile phone.

Patent document US 2012/221475, titled “Mobile Transaction Device Security System”, published on Aug. 30, 2012 defines apparatuses, methods and computer-program products that provide for a unique financial transaction security system. In one embodiment, the financial transaction security system receives a security protocol from a user. The security protocol includes instructions for allowing transactions without authentication and security features for the user if authentication is necessary. The system then determines that the user is conducting a transaction, evaluates the instructions and determines whether the transaction may occur without authentication. If the user is required to authenticate his identity, the system requests an input from the user, compares the input to the security feature, and determines if the user is authenticated. The user is able to customize both the instructions and the security features to provide greater control over financial transaction security. The solution of document US 2012/221475 does not solve common man-in-the-middle attacks if the user device is already compromised by an attacker that submits a transaction that fits the restrictions (i.e., the amount of dollar is allowed by restrictions of the user account). In the present invention, even if the user mobile device is compromised, the transaction remains secure since the wearable device has the ability to show the user if the transaction is compromised by an attacker or not. In order to attack the client side, the attacker must compromise the mobile phone and the wearable device together.

Patent document WO 2009/045798 A1, titled “Method and System for Providing Extended Authentication”, published on Apr. 9, 2009, discloses a method and system for extending an authentication of a wireless device. For example, the method includes authenticating access to the wireless device via a first authentication. The method detects a bounded authentication device as a second authentication. The method allows access to the wireless device when the bounded authentication device is detected. Therefore, the proposed solution of document WO 2009/045798 A1 does not solve common man-in-the-middle attacks if the user device is already compromised by an attacker, since the wearable device is only used to authenticate the user connection and does not provide any feature to verify the transaction integrity outside the compromised device. The present invention assumes that even if the user mobile device is compromised, the transaction remains secure since the wearable device has the ability to show the user if the transaction is compromised by an attacker or not. Thus, in order to attack the client side, the attacker must compromise the mobile phone and the wearable device together.

### SUMMARY

Additional aspects and/or advantages will be set forth in part in the description which follows and, in part, will be apparent from the description, or may be learned by practice of the invention.

The present invention refers to a method for multi-factor authentication, which uses wearable devices as a secondary device in conjunction with a main/primary device (e.g., the user's smartphone which conducts the electronic transaction) to allow the user to verify the integrity of the electronic transaction data before authorizing it or not (outside the possible compromised device, e.g. the smartphone).

Through a main/primary electronic device (e.g., a smartphone) connected to Internet, the user accesses a service provider system in order to conduct an electronic transaction. Once the electronic transaction data have been submitted from the user device to the service provider system via Internet, the service provider system retrieves a one-time password (OTP) from an OTP system connected or embedded to the service provider system, in order to protect/encrypt the transaction data. The user device sends the OTP password to a wearable device using an offline method for transferring data, preferably using Bluetooth technology, but not limited to it, and may be the reading of a QRCode (Quick Response Code). The offline method is important to reduce the risk of wearable device being compromised and controlled over the Internet by the attacker. The said wearable device is preconfigured with the same OTP seed of the OTP system. Once the wearable device has the same OTP of the OTP system, it can decrypt/unprotect the transaction data and show them to the user in the wearable device display, allowing the user to read the transaction data, verify if they were modified and then confirm/authorize the transaction.

The proposed method goes beyond the existing solutions in the prior art, wherein wearable devices are usually used only as tokens, and the user is not able to verify the integrity of the electronic transaction data. Additionally, the existing technologies and solutions fail to improve the security against common attacks (such as man-in-the-middle), since the wearable device is used (as a token) to generate codes or keys to be inserted in already compromised devices (i.e., the codes/keys generated by the wearable device—token—could also be intercepted by a third party).

A system/device implementing the method of the present invention will provide a more secure way to conduct electronic transactions, being more resistant to common attacks (such as man-in-the-middle). Further, it provides a new functionality for wearable devices, the ability of verifying the transaction integrity and then authorizing it or not. Usage/application scope of the proposed method is large, since it is possible to apply it on many kinds of wearable devices with display (e.g., smart watches, smart glasses, etc.), as a secondary device to be used in conjunction with a main device (e.g., smartphone, notebook, etc.).

### BRIEF DESCRIPTION OF THE DRAWINGS

The objectives and advantages of the present invention will become more clear by means of the following detailed description of a preferred but non-limitative embodiment of the invention, in view of its appended figures, wherein:

FIG. 1 is a detailed flowchart representing each step of the method disclosed in the present invention.

FIG. 2 is an overview of usage/application context of the method to authenticate and authorize a transaction of the present invention.

FIG. 3 is an example of the proposed method in the present invention, wherein there is no man-in-the-middle attack.

FIG. 4 is an example of the proposed method in the present invention, wherein there is a man-in-the-middle attack.

FIG. 5 is a variant of the proposed method, wherein the data transmission between the main device and the wearable device occurs by means of a QRCode.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

Nowadays, mobile devices (e.g.: smartphones, tablets, notebooks) are increasingly being used to perform electronic financial transactions via Internet. Such electronic financial transactions include, for example, purchasing products and services, bill payments, transferring funds between bank accounts, etc.

While the (financial) transaction systems and services offered over mobile devices become more valuable, sophisticated and in widespread use, the incidence of fraudulent transactions have also increased. Mobile devices have been successfully hacked, so that the access to “supposedly secure” web sites (such as banking and shopping sites) has become problematic, since the password and/or any other sensitive information (e.g., credit card numbers, bank account information, etc.) may be fraudulently obtained by a third party (also known as man-in-the-middle attack). With this sensitive information, the third party would be able to conduct transactions that typically should be restricted.

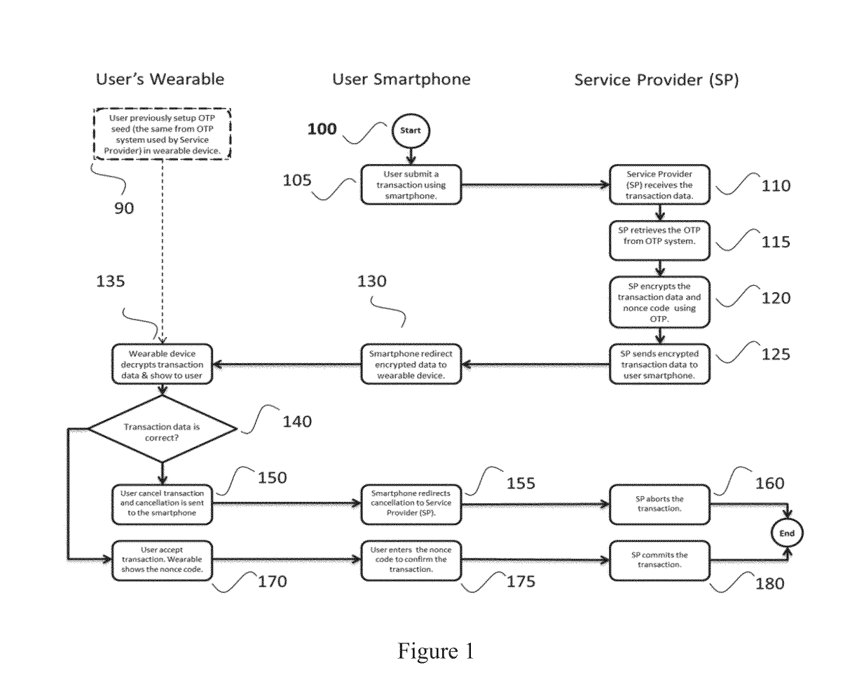

FIG. 1 is a detailed flowchart representing each step of the method 100 disclosed in the present invention. Previously to the usage/operation of the proposed method 100, the user needs to setup 90 the OTP seed in his/her wearable device with the same OTP seed obtained from OTP system assigned to the service provider system.

After preconfiguring 90 the wearable device with the OTP seed, the user can submit a transaction to A service provider SP system via Internet using his/her primary device, e.g. a smartphone 105. Service provider system SP receives the transaction data from smartphone 110 and then retrieves 115 the user OTP password from the respective/assigned OTP system. Service provider system SP performs data encryption 120, for instance through AES-CBC (Advanced Encryption Standard in Cypher Block Chaining) encryption algorithm and Hash-based Message Authentication Code (HMAC) using the retrieved OTP password. Then, service provider system SP creates a new data packet containing the encrypted transaction data and its HMACs, and sends them to the user smartphone 125. Smartphone receives the encrypted transaction data and redirects them to the wearable device 130, preferably using Bluetooth technology (but not limited to it, could be another viable data transfer technology). Since the wearable device stores the same OTP seed of OTP system, it can decrypt transaction data and then check data integrity with the HMAC hash of transaction data 135, so that the user can read the decrypted message and check whether the transaction data is correct or was modified by a third party 140.

If the data was modified, the user can cancel the transaction and the cancellation message is sent to smartphone 150, which redirects 155 the cancellation message to the service provider system SP, and then, service provider system SP aborts the transaction 160.

On the other hand, if the transaction data represents the original transaction, user accepts the transaction and the wearable device shows the nonce code also submitted by the service provider SP into encrypted transaction data 170, so that the user can enter 175 the code provided by the wearable device to confirm the transaction with the smartphone. Thus, the service provider system SP is allowed to commit the transaction 180.

### Overview of Usage/Application Context of the Proposed Method to Authenticate and Authorize a Transaction

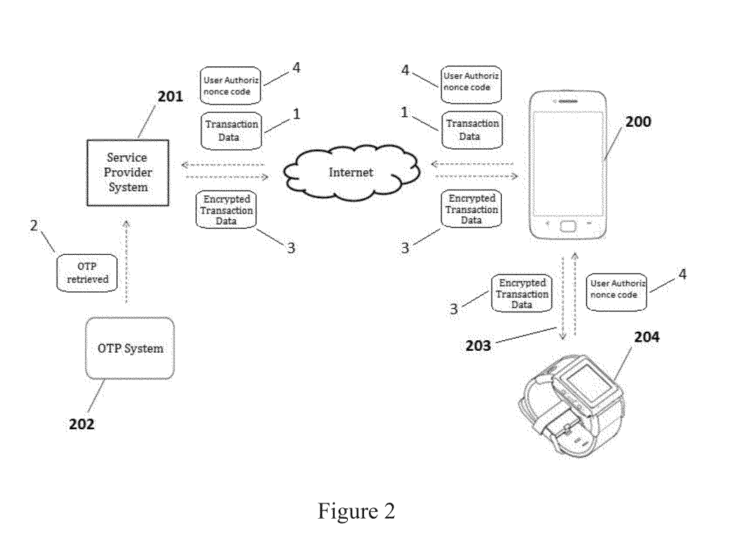

According to FIG. 2, through a main/primary electronic device 200 connected to Internet, the user accesses a service provider system 201 in order to conduct an electronic transaction 105. Once the electronic transaction data 1 is submitted from the user device 200 to the service provider system 201 via Internet 110, the service provider system 201 retrieves 115 an one-time password OTP 2 from an OTP system 202 connected or embedded to the service provider system 201, in order to encrypt 120 the transaction data 3 and then send 125 it back to the user device 200 via Internet. After receiving the encrypted transaction data 3, the user device 200 sends it directly 130 to a wearable device 204 using Bluetooth technology 203. The said wearable device (204) was preconfigured with the same OTP seed of the OTP system 202, used to encrypt the transaction data 3. Since the wearable device 204 has the same OTP password 2 of the OTP system 202, it can decrypt the encrypted transaction data 3, check its integrity comparing the HMAC hash and show 135 it to the user in the wearable device 204 display. The user is then able to read the encrypted transaction data, verify whether it was modified 140 and then confirm/authorize the transaction. With the user authorization 4, the wearable device 204 shows 170 to the user a nonce code sent by service provider system into the encrypted transaction data to confirm the authorization. User enters 175 the code provided by the wearable device into the user device 200 and then it is retransmitted to the service provider system 201, which then commits the transaction 180.

### Examples of the Proposed Method Operation in Two Cases: with No Attack and with Attack

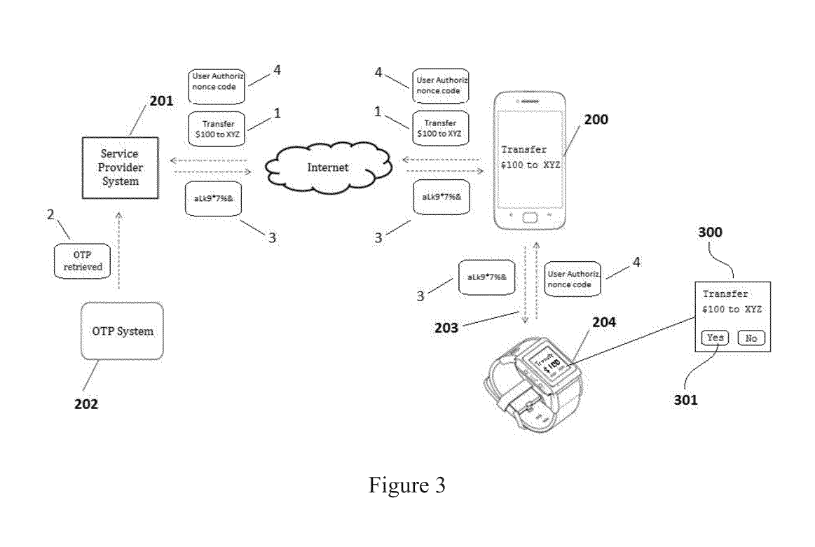

FIG. 3 is an example of the proposed method operation in a case where there is no man-in-the-middle attack. Suppose the user wants to transfer $100 from his/her bank account to a XYZ bank account, and he/she will perform this transaction trough m-banking over mobile phone 200, using his/her smart watch 204 as secondary device for transaction integrity verification. In this case, the mobile phone 200 is not compromised/hacked by a third part. The transaction data m=“transfer $100 to XYZ” 1 is submitted from the user device 200 to the service provider system 201 via Internet safely. The service provider system 201 retrieves an one-time password (OTP) 2 from an OTP system 202, and the service provider system 201 encrypts the transaction data 3, using Encrypt( ) function and producing an unreadable, incomprehensible message, for example:

$$HMAC ( m ) = 45 b 1 e 579 c 4714 d 78 d 791 b 131 ad 30 dee 237 c 74 c 0 d$$

$$\begin{matrix}Encrypted data = Encrypt ( m \text{:} HMAC ( m ) ) \\ = \begin{matrix}6 f & 95 & 4 c & 6 c & 2 d & f 5 & 23 & 25 & 15 & 20 & d 8 & 58 & 25 & Ca & 0 f & d 9 \\ 01 & 6 d & 60 & 01 & 95 & 85 & 9 b & eb & b 6 & d 6 & 72 & 68 & 41 & 07 & 59 & f 8 \\ e 4 & 5 f & 9 f & 66 & 74 & e 7 & ad & 07 & 98 & 83 & Dd & 0 d & fe & Ff & 70 & 94 \\ ab & 70 & c 4 & 2 e & b 3 & 09 & 93 & 26 & 83 & 44 & 50 & 3 a & 33 & e 9 & e 3 & a 9\end{matrix}\end{matrix}$$

which is sent to the user smartphone 200 and redirected to the user smart watch 204. As the user smart watch 204 has the same OTP 2 seed used to encrypt the transaction data 3, it correctly checks data integrity and decrypts transaction data 3, resulting in a readable, comprehensible message (in this case: “transfer $100 to XYZ”), which corresponds to the original transaction sent by the user 300. In this case, user confirms the transaction, for example by touching the smart watch screen/display over the “Yes” option 301. With the user authorization 4, the smart watch 204 shows to the user the nonce code to confirm the authorization. User enters the code (provided by the smart watch) into the smartphone 200 and then it is retransmitted to the service provider system 201, which then commits the transaction (i.e., transfer $100 to bank account XYZ).

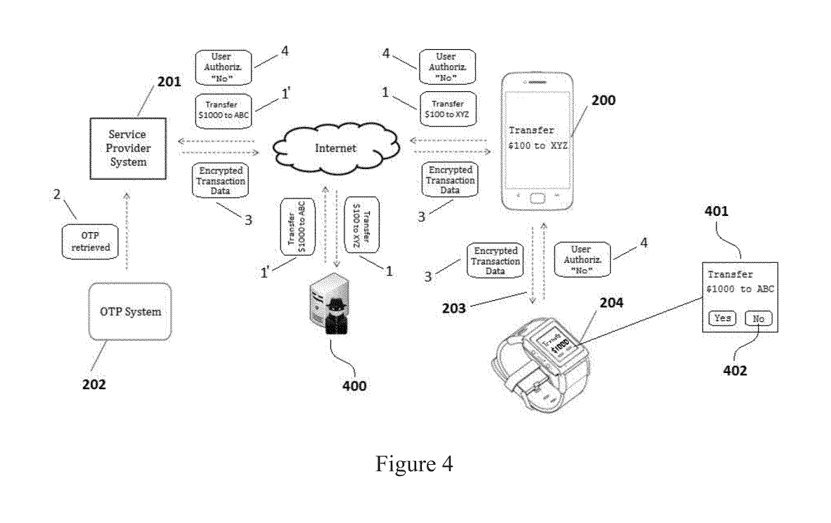

FIG. 4 is another example embodiment of the proposed method operation, but in this case there is a man-in-the-middle attack. Suppose the user wants to perform the same transaction of the example described on FIG. 3, i.e., transfer $100 from his/her bank account to a XYZ bank account. He/she will perform this transaction trough m-banking over mobile phone 200, using his/her smart watch 204 as secondary device for transaction integrity verification. In this specific example, the smartphone 200 is compromised/hacked by a third part system 400. When the transaction data “transfer $100 to XYZ” 1 is submitted from the user device 200 to the service provider system 201 via Internet, a third party system 400 intercepts the transaction data 1 and conducts a distinct electronic transaction. For example, the fraudulent transaction 1′ could be m=“transfer $1000 to bank account ABC”, which is not the original transaction desired by the user. The fraudulent transaction 1′ is then submitted from the third party system 400 to the service provider system 201. The service provider system 201 retrieves an one-time password (OTP) 2 from an OTP system 202, and the service provider system 201 encrypts the fraudulent transaction data 3, producing another unreadable, incomprehensible message, for example:

$$HMAC ( m ) = c 0 f 1857 e 292 e 6 f 8 d 9296 fec 4 c 4 d 8 d 81 d 5 a 530439$$

$$\begin{matrix}Encrypted data = Encrypt ( m \text{:} HMAC ( m ) ) \\ = \begin{matrix}af & 64 & 73 & 90 & 32 & cf & a 8 & 32 & eb & 76 & 4 e & bf & 47 & 3 f & 26 & 1 d \\ 0 e & 6 b & d 7 & a 5 & 0 c & 7 b & 34 & b 3 & 33 & 62 & 71 & 68 & e 8 & 96 & 0 c & Db \\ 70 & 4 e & ea & bc & 84 & 94 & b 6 & 54 & 95 & bb & 85 & 5 c & 84 & 1 f & Ea & fd \\ 3 e & a 3 & 34 & 19 & b 0 & 96 & 2 f & 12 & 13 & 76 & ee & df & aa & 74 & 97 & cb \\ 5 d & 98 & 57 & 05 & ad & 22 & 5 e & 4 c & de & 78 & f 4 & f 5 & 83 & 1 a & 2 e & 5 c\end{matrix}\end{matrix}$$

which is sent via Internet to the user smartphone 200. Again, the third part system 400 can intercept the message, but as it was encrypted 3, the third party system 400 cannot properly read and modify the encrypted transaction data 3 to send a fraudulent message to the user smartphone 200, in order to falsely confirm the original user's electronic transaction.

If the third party system 400 does not modify the encrypted transaction data 3, it arrives to the user smartphone 200 as sent by the service provider system 201. The encrypted transaction data 3 is redirected to the user smart watch 204. As the user smart watch 204 has the same OTP password 2 seed used to encrypt the transaction data 3, it correctly decrypts transaction data 3, resulting in a readable, comprehensible message 401 (in this case: m=“transfer $1000 to ABC”), which does not correspond to the original transaction sent by the user. Additionally, the HMAC hash of the plain text data is verified with the transmitted data in order to guarantee the data integrity. In this case, the user denies the transaction, for example by touching the smart watch screen/display over the “No” option, 402, and then the user response 4 is submitted from the user smart watch 204 to the user smartphone 200. Then, the answer 4 is retransmitted to the service provider system 201, which then aborts/interrupts the fraudulent transaction (i.e., does not transfer $1000 to the bank account ABC).

Supposing the third party system 400 tries to modify the encrypted transaction data 3, considering it does not have access to the OTP 2 seed (for instance, using “brute force algorithms”), it would take a long time to decrypt the message, modify it (to send a fraudulent message to the user), and encrypt it again before sending it to the user smartphone 200. This long procedure (decrypt/modify/encrypt again) would cause a timeout exception and would abort/interrupt the fraudulent transaction (i.e., does not transfer $1000 to the bank account ABC).

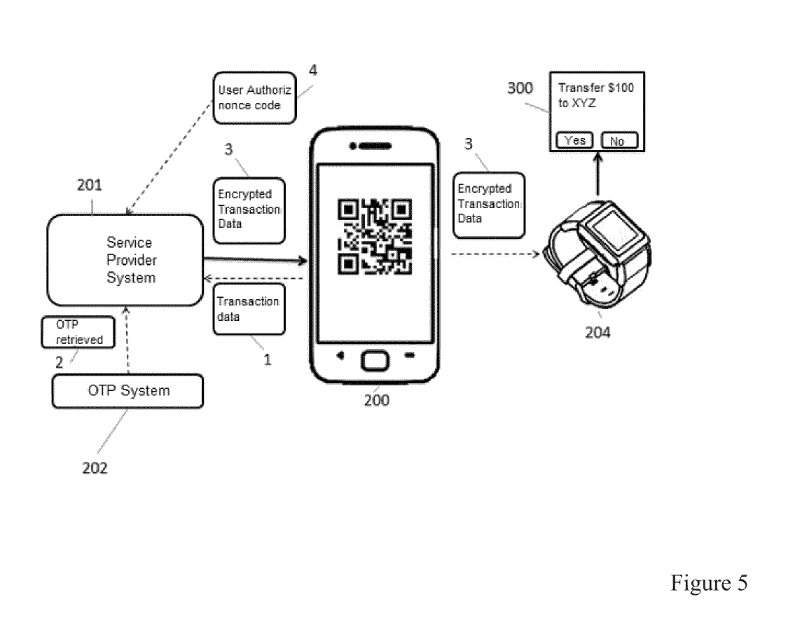

FIG. 5 discloses an example embodiment of the operation of a variant of the proposed method in a case where the data transmission of the transaction is performed through the reading of a QRCode, instead of transmission via Bluetooth as suggested on the proposed method. Suppose the user wants to transfer $100 from his/her bank account to a XYZ bank account, and he/she will perform this transaction through m-banking over mobile phone 200, using his/her smart watch 204 as secondary device for transaction integrity verification. The transaction data m=“transfer $100 to XYZ” 1 is submitted from the user device 200 to the service provider system 201 via Internet safely. The service provider system 201 retrieves an one-time password (OTP) 2 from an OTP system 202, and the service provider system 201 encrypts the transaction data 3, using and Encrypt( ) function and producing an unreadable, incomprehensible message, for example:

$$HMAC ( m ) = 45 b 1 e 579 c 4714 d 78 d 791 b 131 ad 30 dee 237 c 74 c 0 d$$

$$\begin{matrix}Encrypted data = Encrypt ( m \text{:} HMAC ( m ) ) \\ = \begin{matrix}6 f & 95 & 4 c & 6 c & 2 d & f 5 & 23 & 25 & 15 & 20 & d 8 & 58 & 25 & Ca & 0 f & d 9 \\ 01 & 6 d & 60 & 01 & 95 & 85 & 9 b & eb & b 6 & d 6 & 72 & 68 & 41 & 07 & 59 & f 8 \\ e 4 & 5 f & 9 f & 66 & 74 & e 7 & ad & 07 & 98 & 83 & dd & 0 d & fe & Ff & 70 & 94 \\ ab & 70 & c 4 & 2 e & b 3 & 09 & 93 & 26 & 83 & 44 & 50 & 3 a & 33 & e 9 & e 3 & a 9\end{matrix}\end{matrix}$$

which is then disclosed in the main device 200 screen with QRCode format. The user utilizes the camera of the smart watch to read the transaction encrypted data 3. As the smart watch 204 has the same OTP seed 2 used to encrypt transaction data 3, it correctly checks data integrity and decrypts transaction data 3, resulting in a readable, comprehensible message (in this case: “transfer $100 to XYZ”), which corresponds to the original transaction sent by the user 300. In this case, the user confirms the transaction, for example by touching the display screen of the smart watch over the “Yes” option 301. With user authorization 4, the smart watch 204 shows to the user the nonce code to confirm the authorization. User enters the code (provided by the smart watch) into the smartphone 200 and then it is retransmitted to the service provider system 201, which then commits the transaction (i.e., transfer $100 to bank account XYZ).

The example embodiment disclosed in FIG. 5 corresponds to step 130 of the method. Instead of the main device/smartphone redirecting the encrypted data via Bluetooth to the wearable/secondary device, main/smartphone device generates a QRCode on the screen (containing the encrypted information), which is captured by the wearable/secondary device's camera (and then the method/flow follows at the same way). Thus, it is eliminated/reduced another attack vector which would be the Bluetooth communication between the smartphone and the secondary device/smart watch (on the other hand, it would be mandatory that the secondary device be provided with a camera to capture the QRCode).

Despite the examples above have used smartphone and smart watch as primary 200 and secondary 204 devices respectively, the present invention is no limited to these specific devices. Someone skilled in the art can clearly notice that the present invention could use other primary devices (e.g., notebook, tablets, PDAs etc.) and other secondary devices (e.g., smart glasses or any other wearable device with a display to present information to the user), without departing from the spirit and the scope of the present invention.

Although the present invention has been described in connection with certain preferred embodiments, it should be understood that it is not intended to limit the invention to those particular embodiments. Rather, it is intended to cover all alternatives, modifications and equivalents possible within the spirit and scope of the invention as defined by the appended claims.

What is claimed is:

1. Method (100) for multi-factor transaction authentication using wearable devices characterized by comprising the steps of:
previously (90) configuring an OTP seed on a secondary device of user, wherein the OTP seed is the same obtained from the OTP system assigned to the service provider system SP;
submitting (105) a transaction to a service provider using a primary device;
sending (110) transaction data from the primary device of user to the service provider system via Internet;
recovering (115) the OTP password of user from the OTP system allocated in the service provider system;
encrypting the data (120) in the service provider system;
creating a new package containing the encrypted transaction data and sending (125) it for the primary device of user in the service provider system;
receiving transaction data encrypted on the user's primary device and redirect (130) it to the secondary device of user;
decrypting and verifying (135) the integrity of transaction data in the secondary device of user, since it stores the same OTP seed that was used to encrypt the transaction data;
showing the decrypted transaction data on the secondary device of user, so that the user can verify (140) whether the transaction is correct or has been modified by a third party;
if the transaction data has been modified by a third party, cancelling the transaction and sending (150) the cancellation message to the primary device, which redirects (155) the cancellation message to the service provider system, and then the service provider system aborts the transaction (160);
if the transaction data is correct, accept the transaction and show (170) the nonce code in the wearable device, so that the user can enter (175) the code provided by the wearable device to confirm the transaction on the primary device, so that the service provider system is allowed to commit the transaction (180).

2. Method (100) for multi-factor transaction authentication using wearable devices, according to claim 1, characterized in that the step of encrypting the data (120) by the service provider (SP) system comprises the usage of AES-CBC encryption algorithm (Advanced Encryption Standard in Cypher Block Chaining) and Hash-based message Authentication code (HMAC) using OTP password retrieved as the key code.

3. Method (100) for multi-factor transaction authentication using wearable devices, according to claim 2, characterized in that the step of creating the data package by the service provider (SP) system and sending it to the primary device of user (125) comprises the inclusion of the encrypted transaction data (3) and its HMACs.

4. Method (100) for multi-factor transaction authentication using wearable devices, according to claim 1, characterized by the fact that forwarding (130) the encrypted transaction data from the first device (200) of user to the wearable device (204) of user comprises the usage of technology for data transmission, preferably Bluetooth.

5. Method (100) for multi-factor transaction authentication using wearable devices, according to claim 1, characterized by the fact that the step of verifying the transaction data (135) is performed with the HMAC hash of the transaction data.

6. Method (100) for multi-factor transaction authentication using wearable devices, according to claim 1, characterized by the fact that the wearable devices (204) of user comprise smart watches, smart glasses, and other smart devices.

7. Method (100) for multi-factor transaction authentication using wearable devices, according to claim 1, characterized by the fact that the primary device (200) comprises smartphones, notebooks, PDAs, tablets, and other devices with processing capability.

8. Method (100) for multi-factor transaction authentication using wearable devices, according to claim 1, characterized by the fact that the redirection in the step of receiving the encrypted transaction data (3) in the primary user device and redirecting it (130) for the secondary device of user comprises reading an encrypted QRCode on the primary device (200) with a camera of the secondary device (204).
